(19) United States
(12) Patent Application Publication
(10) Pub. No.: US 2024/0407362 A1
(43) Pub. Date: Dec. 12, 2024

(54) ENHANCED PLANT GROWTH VIA PROCESSED PLANT CELL WALL MATERIAL

(71) Applicant: The Regents of the University of Michigan, Ann Arbor, MI (US)

(72) Inventors: Alper KIZILTAS, Dearborn, MI (US); Erik NIELSEN, Ann Arbor, MI (US); Alan TAUB, West Bloomfield, MI (US); Mihaela BANU, Ann Arbor, MI (US); Xhulja BIRAKU, Westland, MI (US)

(21) Appl. No.: 18/737,473

(22) Filed: Jun. 7, 2024

Related U.S. Application Data
(60) Provisional application No. 63/471,918, filed on Jun. 8, 2023.

(51) Int. Cl. A01N 43/16; A01N 25/02; A01N 25/34; A01N 65/00; A01P 21/00

(52) U.S. Cl. CPC A01N 43/16; A01N 25/02; A01N 25/34; A01N 65/00; A01P 21/00

(57) ABSTRACT

Methods of plant growth are performed in the presence of nanocellulose, processed plant cell wall material, and/or processed plant cell wall polysaccharides. These methods enhance all stages of plant growth, from seed germination to vegetative growth and also promote root growth from cut stems that are normally unable to propagate roots. The methods are based on the discovery that plants can indeed access cellulosic polysaccharides when the cellulose is processed to a sufficiently small size.

### TECHNICAL FIELD

The present disclosure relates to methods of and materials for enhancing plant growth.

### BACKGROUND

It has been known that plants use organic carbon in the soil since the original plant tissue culture experiments in the early 1950s. Murashiga and Skoog, among others, showed that plant cells could be grown and propagated in tissue cultures with a subset of essential elements. Importantly, however, these cell lines were non-photosynthetic cells—i.e., cultured plant cells are derived from non-photosynthetic precursors such that the resultant cells are also non-photosynthetic. The basic plant growth medium includes sucrose to provide the carbon necessary to propagate these non-photosynthetic cell lines. For some 70 years since then, these nutrient requirements have been used to support plant growth in tissue cultures with essentially no question why sucrose is provided as part of the growth medium.

Another assumption that has gone essentially unquestioned is that plants cannot degrade cellulose, as evidenced by the fact that plants do not degrade cellulose when they are together. The generally accepted premise is that cellulose-degrading microbes express glycolytic enzymes that contain specific protein domains that allow them to preferentially associate with cellulose and that this ability—cellulose affinity—is what predicates the ability of these organisms to effectively digest cellulose while most other organisms cannot. The reason plants do not degrade their own cellulose is assumed to be because they do not encode enzyme proteins in their genomes that have these cellulose-association domains.

### SUMMARY

Embodiments of a method include plant growth in the presence of nanocellulose.

The method may additionally include any technically feasible combination of the following features:
the plant growth includes germination of a plant seed;
the plant growth includes causing roots to grow from a cut plant stem;
the plant growth includes watering a plant with a solution comprising the nanocellulose, for example at a concentration of less than 20 grams nanocellulose per liter of water or from 0.5 to 5 grams nanocellulose per liter of water;
the nanocellulose is in the form of nanofibers;
the nanocellulose is crystalline nanocellulose;
the nanocellulose has an average length of 200 nanometers or less;
at least 30% of the nanocellulose is non-crystalline polysaccharides;
from 30% to 40% of the nanocellulose is non-crystalline polysaccharides;
the nanocellulose is modified to include a moiety comprising at least one of: nitrogen, phosphorous, potassium.

Embodiments of a method include plant growth in the presence of plant cell wall material that has been processed to have an average particle size sufficiently small to permit the plant cell wall material to be accessed as a carbon source during the plant growth.

The method may additionally include any technically feasible combination of the following features:
the plant cell wall material includes microcellulose;
the plant cell wall material includes nanocellulose;
the plant cell wall material includes nanofibers;
the plant cell wall material includes non-crystalline cellulose.

Embodiments of a method include plant growth in the presence of plant cell wall polysaccharides processed to have individual particle sizes on a microscale or smaller. The particle sizes may be on a nanoscale and/or the polysaccharides may be in the form of nanocellulose.

### BRIEF DESCRIPTION OF DRAWINGS

FIG. 1A is a photographic image of the vegetative end of a flax stem after treatment in plain water;

FIG. 1B is a photographic image of the vegetative end of a flax stem after treatment in a 2 g/L nanocellulose solution;

FIG. 1C is a photographic image of the vegetative end of a flax stem after treatment in a 20 g/L nanocellulose solution;

FIG. 1D is a photographic image of the cut end of the flax stem of FIG. 1A;

FIG. 1E is a photographic image of the cut end of the flax stem of FIG. 1;

FIG. 1F is a photographic image of the cut end of the flax stem of FIG. 1C;

FIG. 2 is an example of a cross-section of a flax stem used to calculate a ratio of cell wall area to lumen area for control samples and treated samples;

FIG. 3 illustrates the ratio of cell wall area to lumen area at three locations along the stem for control plants and nanocellulose-treated plants;

FIG. 4A is a photographic image of germination control seeds;

FIG. 4B is a photographic image of germination of nanocellulose-treated seeds;

FIG. 5A is a photographic image of the seeds of FIG. 4A after additional growth;

FIG. 5B is a photographic image of the seeds of FIG. 4B after the same amount of additional growth as the seeds of FIG. 5A;

FIG. 6 illustrates distributions of weights of nanocellulose-treated plants compared to control plants;

FIG. 7 illustrates average root weights of nanocellulose-treated plants compared to control plants;

FIG. 8 is a photographic image of the roots of nanocellulose-treated plants; and

FIG. 9 is a photographic image of the roots of control plants after the same amount of growth time as the plants of FIG. 8.

### DESCRIPTION OF EMBODIMENTS

The discoveries and findings presented below challenge the above-described assumptions at a fundamental level. The result is embodiments of a game-changing invention that has the potential to transform agriculture in a manner unrecognized since the advent of nitrogen fixation in the early 20th century or Borlaug's Green Revolution of the 1960s.

Described below is a novel use for highly processed plant wall material such as nanocellulose. Initial experiments aimed at enhancing the growth rate and/or the fiber structure of flax plants to make them more useful producers of fibers for use as composite reinforcements have led to the discovery that these micro- or nanoscale extracts of plant cell wall material promote root growth from plant seeds and cut stems, thereby increasing the likelihood of establishment of a robust plant. This is in addition to observable changes in plant growth rate and fiber structure within the plant stems compared to control samples grown in the absence of processed cell wall material.

An illustrative method includes plant growth in the presence of nanocellulose. Another illustrative method includes plant growth in the presence of plant cell wall fractions that are sufficiently small to be accessed as a carbon source during plant growth. Another illustrative method includes plant growth in the presence of plant cell wall polysaccharides processed to have individual particle sizes on a microscale or smaller.

As used herein, “plant growth” includes every stage of plant growth from seed germination to root development to vegetative growth through flower and/or fruit production, where applicable. As used herein, “nanocellulose” and “microcellulose” are highly processed plant cell wall materials composed primarily of crystalline native cellulose (beta-1,4-glucan polymer) with distinct domains or particles on a respective nanoscale or microscale. A nanoscale particle has a largest dimension of less than 500 nm. A microscale particle has a largest dimension greater than or equal to 500 nm and less than 500 μm. The particles may be characterized based on their aspect ratio as fibers (e.g., nanofibers or microfibers) when they have an aspect ratio of 5 or greater.

“Processed” means that the size of naturally occurring polysaccharide fibers and/or molecules has been reduced by human intervention rather than through natural oxidation or microbial degradation. Processing may entail mechanical work on plant cell wall material, such as crushing, grinding, or other pulverization techniques. Processing may also include chemical or enzymatic treatment, for example to remove one or more non-cellulosic material (e.g., lignin) from the plant cell wall material or cleaving cellulose or other polysaccharide molecules to lower their average molecular weight while preserving the native structure. Processing may also include the addition of energy, such as sonic or ultrasonic vibration, UV light, or heat, to break down plant cell wall material while leaving at least some of the basic polysaccharides structures intact.

The processed plant cell wall material may also be characterized by its crystalline cellulose content and/or its fractional cellulose content. In one embodiment, the processed cell wall material is in the form of microfibers or nanofibers composed of at least 50% crystalline cellulose with the remainder being non-crystalline cellulose and/or other plant cell wall polysaccharides (e.g., hemicellulose and pectin polysaccharides). In another embodiment, the processed cell wall material is cellulose nanofibers (CNF) comprising 60% to 70% crystalline cellulose and 30% to 40% non-crystalline cellulose and/or other plant cell wall polysaccharides. Nanocellulose may therefore include plant cell wall polysaccharides other than cellulose, and the same can be said for microcellulose. The nanofibers or microfibers may have an aspect ratio in a range from 3 to 350 or in a range from 10 to 250. The fibers may have a lengthwise dimension of 1000 nm or less, 500 nm or less, 200 nm or less, in a range from 100 nm to 1000 nm, or in a range from 200 nm to 500 nm. The fibers may have a width of 20 nm or less, 10 nm or less, 5 nm or less, in a range from 3 nm to 20 nm, or in a range from 5 nm to 20 nm.

In another embodiment, the processed plant cell wall material is in the form of particles having an aspect ratio of less than 5 and having a composition including at least 50% crystalline cellulose with the remainder being non-crystalline cellulose and/or other plant cell wall polysaccharides. In a specific embodiment of nanoparticles, the nanocellulose is crystalline nanocellulose (CNC), which are nanoparticles comprising at least 90% or at least 95% crystalline cellulose. The particles of CNC may have a largest dimension of 200 nm or less, 100 nm or less, 50 nm or less, or a largest dimension in a range from 30 nm to 50 nm.

The method may include treatment of a plant seed with nanocellulose or other sufficiently processed cell wall material to initiate germination and/or to stimulate root growth from the plant seed prior to the vegetative phase of growth. The method may alternatively or additionally include treatment of a cut plant stem with sufficiently processed cell wall material to stimulate and/or induce root growth from the cut stem and thereby form a new plant. The plant stem is cut from a living plant and, as discussed further below, root growth can be induced on cut stems of plants that do not normally produce adventitious roots.

The treatment may include watering the seed, plant, or cut stem with a solution that includes nanocellulose or microcellulose. In a non-limiting example, the solution includes 0.5 to 5 grams of nanocellulose per liter of water. It has also been found advantageous in some cases to limit the amount of nanocellulose in the solution to less than 20 grams per liter of water.

The processed plant cell wall material, such as nanocellulose, is believed to provide a mobilized form of glucose and/or other sugars that are usable by seeds or plants in place of sucrose. Sucrose is the main disaccharide sugar used for long-distance transport of carbon from plant source tissues, such as mature leaves that are photosynthetically active, to non-photosynthetic sink tissues, such as roots. Sink tissues utilize sucrose as an energy source and as the carbon backbones for subsequent synthesis of the majority of the biological molecules required for the production of new plant cells and tissues. Supplementation of tissue culture media with sucrose is widely used for in vitro plant growth. It has now been discovered that plant growth is enhanced not only by supplementation with sucrose, but also if grown in the presence of highly processed plant cell wall material such as nanocellulose. As demonstrated and discussed below, plants treated with these materials display marked growth enhancement both in tissue culture conditions and in greenhouse conditions in a soil medium.

### Experimental Examples

Plant growth in the presence of nanocellulose was studied using Linum usitatissimum (flax) and Arabidopsis thaliana (thale or mouse-ear cress) as the subject plants.

Flax is a monocotyledonous plant widely planted both for the nutritional benefits associated with its seeds and for the strong bast fibers it produces. Flax fibers are commonly used in the production of textiles (e.g., linen) and rope and has been more recently considered as a reinforcing material in polymer composites in place of traditional glass fibers. Enhancing the growth and yield of this and other important crop species, particularly in marginal soils that are not currently agronomically productive or in especially underdeveloped or very harsh plant growth conditions (e.g., the Moon or Mars) has far reaching implications. For example, the ability to grow flax and other economically significant plants in currently underutilized rural areas and their inclusion in the process chain for the fabrication of fiber-reinforced composites in advanced industry may provide significant economic development benefits in those areas.

Mouse-ear cress is the primary research model for dicotyledonous plants and is used due to its ease of growth and propagation in the laboratory and due to the myriad of post-genomic resources available for this plant. These publicly available resources may aid in future discoveries related to: 1) how plants detect the presence of nanocellulose, 2) what specific glycosyl hydrolytic enzymes (or other plant-produced compounds) are responsible for mobilizing carbon from nanocellulose, and 3) what metabolic processes are modified or enhanced within plants in order to utilize the mobilized carbon released from nanocellulose to enhance plant growth and development.

Flax plants (variety Agatha, obtained from Fibrevolution, LLC, Willamette Valley, Oregon) were grown from seed in a growth chamber and exposed to alternating periods of 16 hours of continuous light and 8 hours of continuous darkness at a temperature of 20° C. The plants were collected 45 days after they were sown by cutting the root stem of the plants. Some of the cut plants were used as control plants, with the cut end of the stem placed in untreated sterilized water, and some of the cut plants were used as test plants, with the cut end of the stem placed in a solution of nanocellulose in water. The nanocellulose solution for one group of test plants had a concentration of 0.1 grams nanocellulose per 50 mL of water (0.2% w/v or 2 g/L), and the nanocellulose solution for another group of test plants had a concentration of 1 gram nanocellulose per 50 mL of water (2% w/v or 20 g/L). The nanocellulose in this case was CNF (obtained from Sappi, Boston, MA).

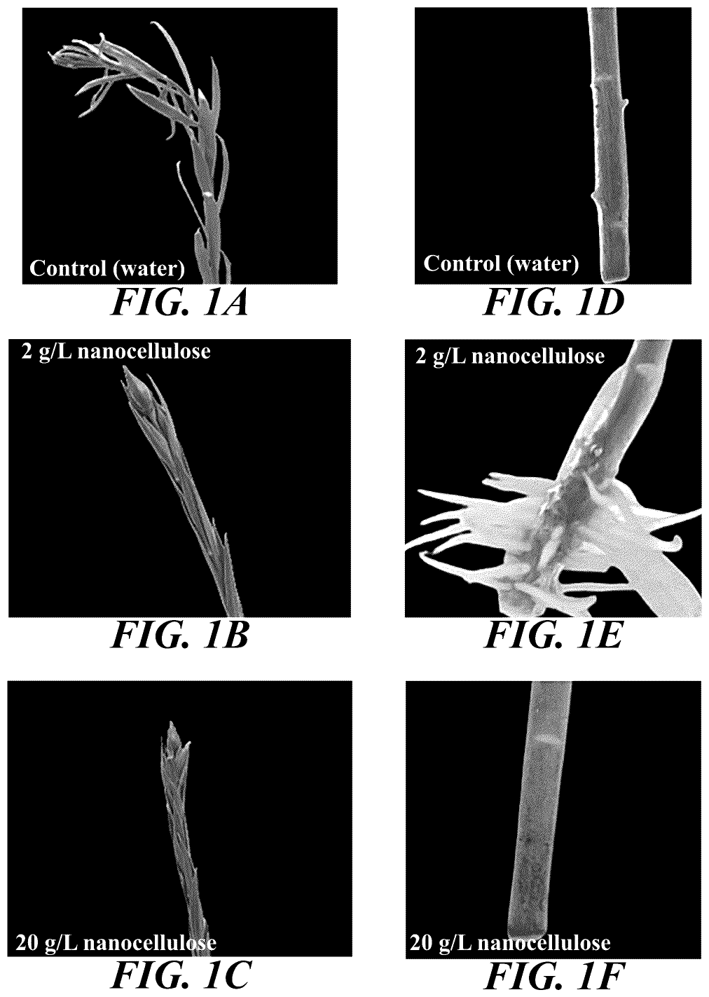

FIGS. 1A-1F include photographic images of the vegetative end (top) and cut end (bottom) of the three groups after 9 days of treatment. Generally, the nanocellulose-treated plants fared better than the control plants. The floral portion of the control plant (FIG. 1A) bent under its own weight, while the floral portion of each of the treated plants (FIGS. 1B-1C) remained relatively straight, apparently maintaining their strength. Additionally, the control plant (FIG. 1A) was yellowed in comparison to a healthy-looking green color of the treated plants (FIGS. 1B-1C). One of the nanocellulose test plants grew roots at the cut end of the stem (FIG. 1E), while the control plant and test plant in the higher concentration nanocellulose solution did not. Roots began forming in the lower concentration nanocellulose solution after 6-8 days of treatment.

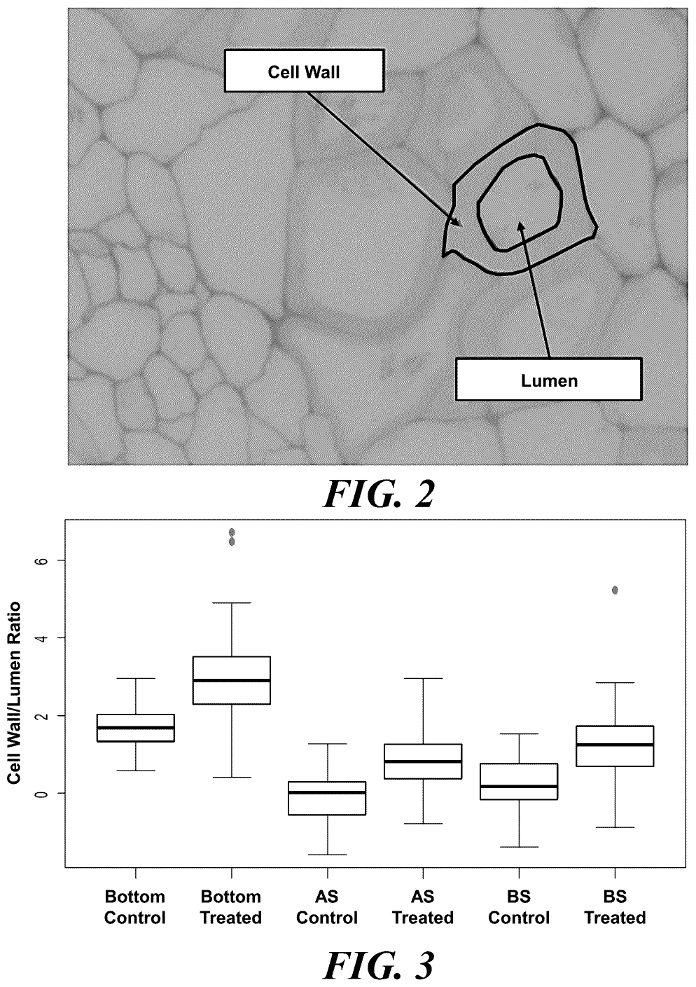

To evaluate the effect of nanocellulose treatment on the flax fibers, 20× images of stained stem cross-sections were used to calculate a ratio of cell wall area to lumen area for control samples and treated samples, as illustrated by way of example in FIG. 2. Cross-sections were evaluated at three points along the stems: above snap point (AS), below snap point (BS), and at the bottom of each plant. As shown in FIG. 3, the ratio of cell wall area to lumen area was increased at all three locations along the stem for the nanocellulose-treated plants.

Arabidopsis was grown from seed in controlled conditions (on plates) and in uncontrolled conditions (in soil). The out-of-soil medium formulation for both the control plants and the treated plants included Murashige and Skoog plant growth medium, an MES buffer, and PhytagelTM in water with the pH adjusted to a range from 5.8 to 6.0 with KOH. The medium formulation for the control plants additionally included nanocellulose in the form of CNF paste.

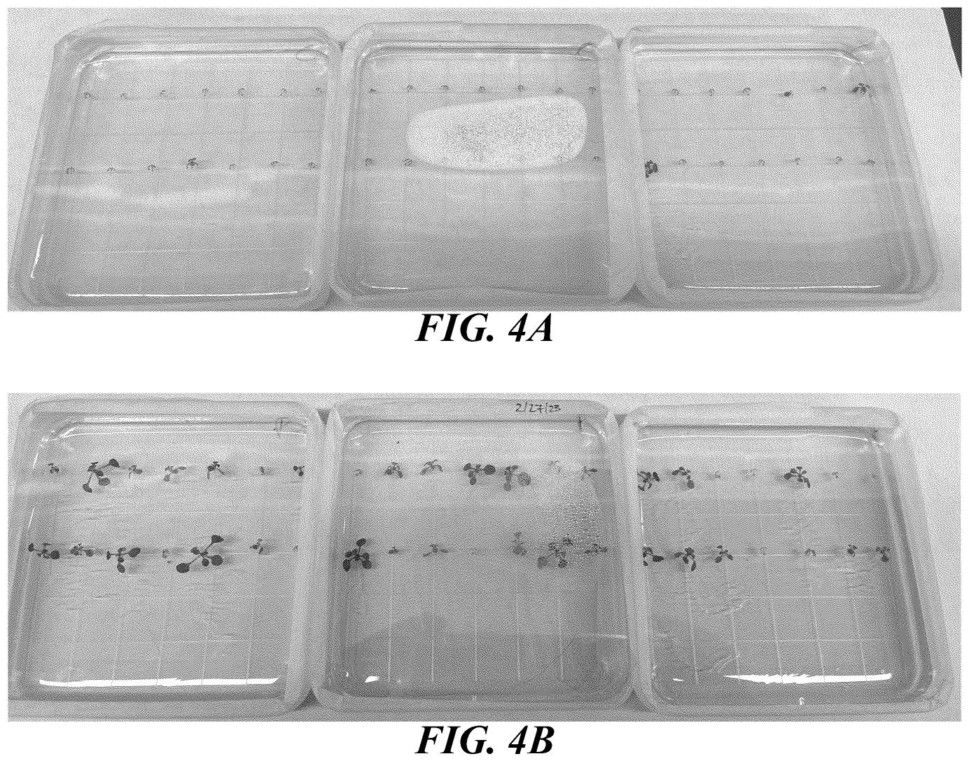

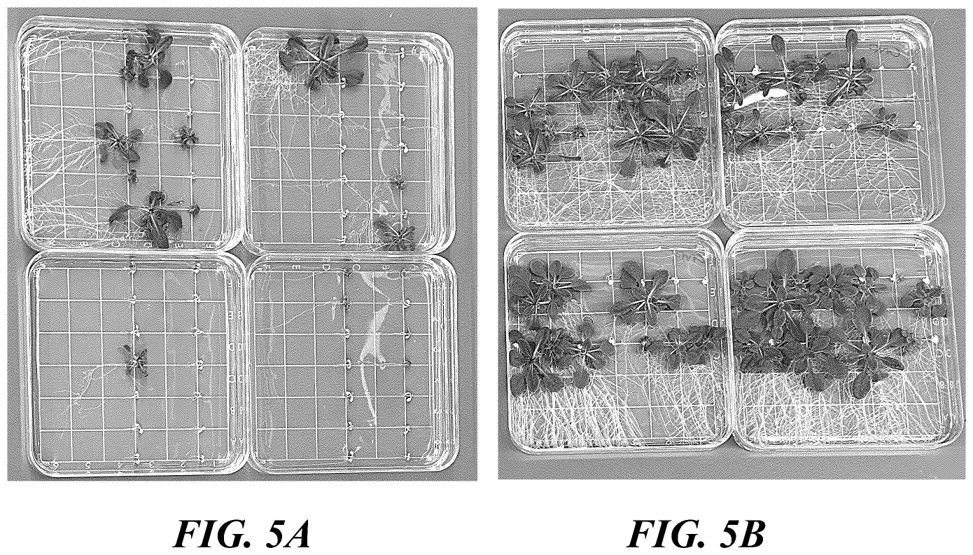

FIGS. 4A and 4B are respective photographs of the control seeds and the nanocellulose-treated seeds after the same amount of time and illustrate the enhanced germination in the presence of nanocellulose.

FIGS. 5A and 5B are respective photographs of the control plants and the nanocellulose-treated plants after the same amount of additional time and illustrate the enhanced success in plant growth, size of plant growth, and amount of root growth in the presence of nanocellulose.

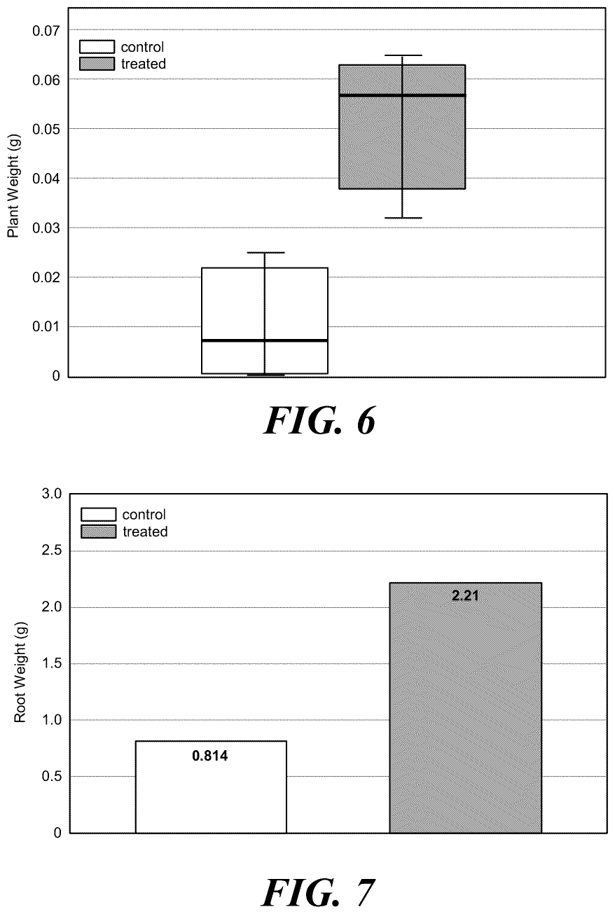

The germination success rate was 50% for the nanocellulose-treated plants and 8.1% for the untreated control plants. FIG. 6 illustrates distributions of plant weights for the control plants compared to the nanocellulose-treated plants after the same amount of growth time, where the additional growth of the treated samples is clearly significant. Notably, the treated plants thrived even in the absence of sucrose and vitamins in the growth medium.

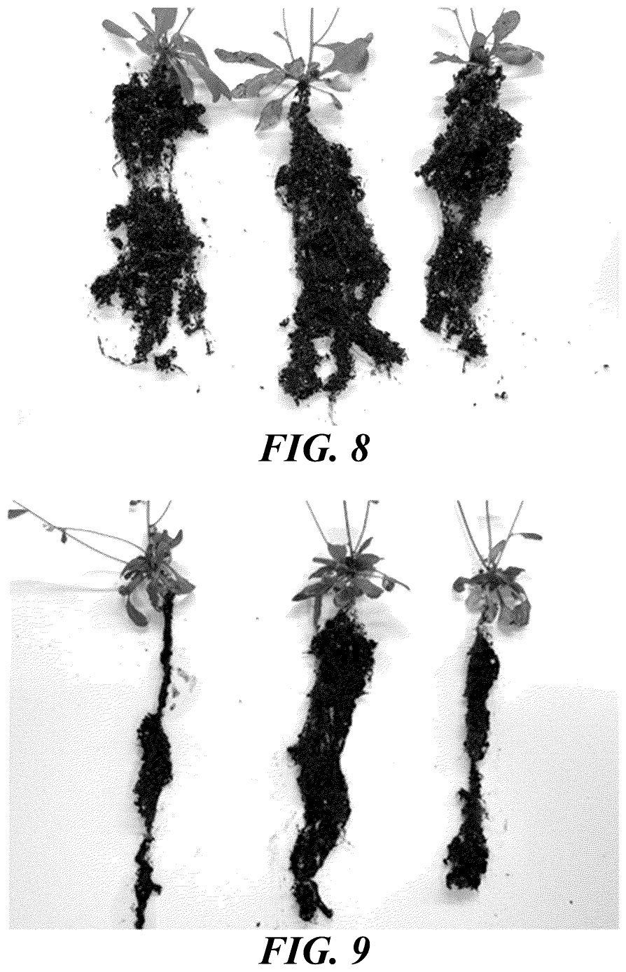

Turning to the Arabidopsis plants in uncontrolled soil conditions, FIG. 7 illustrates the average weight of the roots for the control plants compared to the nanocellulose-treated plants after the same amount of growth time, where the additional root mass of the treated samples is clearly significant. This is illustrated qualitatively in FIGS. 8 and 9, which are respective photographs of the roots of the treated plants and the control plants as extracted from the soil after the same amount of growth time. The roots of the treated plants (FIG. 8) grew longer and more numerous and with more branches that the roots of the control plants (FIG. 9).

From these experimental examples, it can be surmised that plant growth can be stimulated through root proliferation in the presence of a nanocellulose solution. For example, a plant germinated in the presence of nanocellulose can be stimulated to produce roots more quickly and more numerous when compared to untreated plants. Specifically, when an ungerminated seed is planted in the presence of nanocellulose, either on a solid, artificial plant growth medium or in soil, the germination of this seed can be accelerated with prominent root development in 1 to 3 days, while untreated seeds germinate more slowly, generate fewer roots, and display overall smaller plant size. As a plant reaches maturity (e.g., 3 to 4 weeks) when grown in the presence of nanocellulose, it can achieve an larger overall plant size and develop significantly larger root systems that have more roots than untreated plants.

Additionally, when the aerial portion of a mature flax plant is fresh-cut along its stem (i.e., separated from its roots) and placed in a solution containing nanocellulose, the cut stem can produce significant numbers of adventitious roots and can also exhibit enhanced viability within 5 days of continued growth. This is contrary to the behavior of fresh-cut mature flax stems placed in water, which generally fail to produce roots, wilt, and often die with a few days.

While these experimental results are based on CNF as the nanocellulose, crystalline nanocellulose (CNC) is expected to provide similar plant growth benefits due at least in part to the highly processed nature of the material, which similarly provides lower molecular weight cellulose molecules and increased surface area of the distinct cellulosic domains in the processed material. However, it may also be the case that the non-crystalline portion of the nanocellulose, which as noted above may contain up to 40% non-crystalline cellulose and/or other plant cell wall polysaccharides, is at least partially responsible for the enhance plant growth.

The above-described observation that plants, either themselves in sterilized in vitro tissue culture conditions or, likely, in combination with beneficial rhizobial microbes in soil, are able to efficiently mobilize and utilize carbon previously fixed in plant cell walls has potentially profound agricultural implications. For instance, at maturity, the majority of the nutritional value of crop plants comes from their reproductive organs (i.e., fruits and seeds). While growing to maturity, most annual crop species mobilize much of the assimilated proteins, lipids, and carbohydrates that they have accumulated during their growth cycle into these reproductive organs. Once mature, the remaining cell wall structures that constitute the vegetative parts of the plant have limited nutritional value for most animals outside of ruminants (e.g., cattle or sheep) because most animals do not produce the enzymes necessary to break down cellulose. This leftover vegetative material and its largely cellulosic cell wall material is often tilled back into the soil, where soil-based microbes then begin to break it down, enriching the soil for future crop growth. For a limited number of annual crops, fibrous elements of the plants can be used for industrial purposes (e.g., flax fibers), or the cell wall material can be processed into silage, straw, or hay to assist in feeding ruminant cattle.

The present discovery changes what was once waste vegetative material into a plant growth enhancer. The above-discussed results indicate that plants grown in the presence of nanocellulose can access the sugars present in the cellulose and mobilize this carbon source in order to promote growth. This means that a widely available byproduct of crop production—i.e., plant cell wall material in the form of plant leaves and stems, for example—if appropriately processed and extracted can dramatically improve plant growth and development.

In addition to the potential for improved agricultural production, these highly processed extracts of plant cell wall material are largely comprised of insoluble polysaccharides. This raises the possibility for targeted delivery of nutrients precisely to the soil in the immediate vicinity of newly planted seeds or seedlings without the polluting effects of run-off associated with traditional nitrogen-based fertilizers. This may significantly increase the efficiency of use of this material as a fertilizer as it would theoretically reduce the total amount of material required to effectively promote plant growth over common commercial fertilizer preparations that are often sprayed in liquid form over the surface area of the entirety of a crop field. Additional chemical modification of nanocellulose could serve as targeted molecular platforms to deliver other limiting organic elements (e.g., N and P) precisely to the soil at the site of the growing plant. In one example, nanocellulose could be chemically modified to include amine groups that could deliver nitrogen directly to the seeds or roots of a plant without being washed away as a pollutant.

It is currently believed that most land plants do not efficiently degrade plant cell wall material if that material remains largely intact at the plant tissue or organ scale. In mature plant tissues, incorporation of lignin and other chemical crosslinking processes alters these plant cell wall structures in ways that make it particularly recalcitrant to enzymatic degradation. The premise, which is generally accepted, is that cellulose-degrading microbes express specifically evolved glycolytic enzymes that contain protein domains that significantly increase the affinity to these enzymes for lignocellulosic structures. This increased affinity is what predicates the ability of these organisms to effectively degrade cellulose into its constitutive sugars, while most other organisms cannot. Plants, which do not appear to express similarly organized glycolytic enzymes, are therefore believed normally to be unable to mobilize sugars efficiently from intact plant cell wall material. However, the highly processed nature of nanocellulose leaves it largely devoid of lignin, which is removed during processing and extraction. Additionally, the high degree of maceration that occurs during production of nanocellulose also dramatically increases the surface to volume ratio of the individual domains of the material. Both the reduction in lignin content and the mechanical work imparted on the material when producing nanocellulose may contribute to altering the ability of plant glycolytic enzymes to efficiently mobilize sugars from these highly processed cell wall materials.

Regardless of the precise molecular mechanisms, these highly processed extracts of plant cell wall material clearly demonstrate a significant plant growth promoting activity. In modern agriculture, improvements in crop yield are often incremental and additive. A combined set of agricultural improvements, including introduction of specific isogenic cultivars, use of hybrid lines, and intensive irrigation and fertilization regimes that are generally termed “The Green Revolution,” is largely credited with saving more than one billion lives around the world in the latter half of the 20th century. The sum of these advances which occurred between roughly 1960-2000 resulted in increases in crop yields of ˜200% for wheat, ˜100% for rice, ˜150% for maize, and ˜75% for potatoes. Against this backdrop, the increases in plant growth observed in the initial nanocellulose experiments presented above are genuinely striking.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method comprising plant growth in the presence of nanocellulose.

2. The method of claim 1, wherein the plant growth comprises germination of a plant seed.

3. The method of claim 1, wherein the plant growth comprises causing roots to grow from a cut plant stem.

4. The method of claim 1, wherein the plant growth comprises watering a plant with a solution comprising the nanocellulose.

5. The method of claim 4, wherein the solution comprises less than 20 grams nanocellulose per liter of water.

6. The method of claim 4, wherein the solution comprises from 0.5 to 5 grams nanocellulose per liter of water.

7. The method of claim 1, wherein the nanocellulose is in the form of nanofibers.

8. The method of claim 1, wherein the nanocellulose is crystalline nanocellulose.

9. The method of claim 1, wherein the nanocellulose has an average length of 200 nanometers or less.

10. The method of claim 1, wherein at least 30% of the nanocellulose is non-crystalline polysaccharides.

11. The method of claim 1, wherein from 30% to 40% of the nanocellulose is non-crystalline polysaccharides.

12. The method of claim 1, wherein the nanocellulose is modified to include a moiety comprising at least one of: nitrogen, phosphorous, potassium.

13. A method comprising plant growth in the presence of plant cell wall material that has been processed to have an average particle size sufficiently small to permit the plant cell wall material to be accessed as a carbon source during the plant growth.

14. The method of claim 13, wherein the plant cell wall material includes microcellulose.

15. The method of claim 13, wherein the plant cell wall material includes nanocellulose.

16. The method of claim 13, wherein the plant cell wall material includes nanofibers.

17. The method of claim 13, wherein the plant cell wall material includes non-crystalline cellulose.

18. A method comprising plant growth in the presence of plant cell wall polysaccharides processed to have individual particle sizes on a microscale or smaller.

19. The method of claim 18, wherein the particle sizes are on a nanoscale.

20. The method of claim 18, wherein the polysaccharides are in the form of nanocellulose.
